(19) United States
(12) Patent Application Publication
(10) Pub. No.: US 2013/0051046 A1
(43) Pub. Date: Feb. 28, 2013

(54) LED APERTURE OF AUTOMOBILE LAMP

(71) Applicant: KENG-CHIN YEH, NEW TAIPEI CITY 22044 (TW)

(72) Inventor: KENG-CHIN YEH, NEW TAIPEI CITY 22044 (TW)

(73) Assignee: GRANG FAIR INDUSTRIAL CO., LTD., NEW TAIPEI CITY 22044 (TW)

(21) Appl. No.: 13/217,363

(22) Filed: Aug. 25, 2011

(51) Int. Cl. B60Q 1/26

(52) U.S. Cl. 362/487

(57) ABSTRACT

An LED aperture of an automobile lamp comprises a PCB having LED lamps installed with a wide interval apart from each other and at least two notches formed at the external periphery of PCB, such that each LED lamp is near an internal side of the light collection ring cover, and a transparent light collection ring cover including refractive engraved lines on the light collection ring cover, and at least two latch sections extended from the internal periphery of the light collection ring cover and aligned with the notches of the PCB. The LED lamps form an aperture with a uniform brightness and lights of a light source passed through a plurality of refractive engraved lines are formed on a surface of the light collection ring cover achieve the expected safety warning and decoration function and lower the cost of the LED lamps.

### BACKGROUND OF THE INVENTION

1. Field of the Invention

The present invention relates to an improved LED aperture of an automobile lamp, and more particularly to an LED aperture that can be installed in headlights or rear lights of a motor vehicle, and LED lamps are distributed with an interval apart from one another and proximate to an inner side of a transparent light collection ring cover, so that when the LED lamps are turned on with the automobile lamps and used for projecting lights, refractive engraved lines formed on a surface of the light collection ring cover constitute an aperture with an emitted light source having a uniform brightness to achieve expected safety warning and decoration functions.

2. Description of the Prior Art

At present, an LED aperture module installed at headlights or rear lights usually includes LED lamps densely installed on a surface of a printed circuit board (PCB), and the PCB with densely installed LED lamps is installed in a transparent light collection ring cover and proximate to an external section to allow the light source of the LED installed at the periphery of the headlights or rear lights to be projected to the outside through the light collection ring cover in order to provide a warning function, when the automobile lights are turned on.

However, only a portion of the light source of the LED aperture installed in the headlights or rear lights has effects with the light collection ring cover. As a result, the light projected to the outside has higher brightness at positions near the light collection ring cover and weaker brightness at positions away from the light collection ring cover, and a light source in form of a circular ring and the LED aperture with a uniform brightness cannot be achieved under the projection of the automobile lights, and the PCB t with densely installed LED lamps incurs a higher cost.

### SUMMARY OF THE INVENTION

The present invention overcomes the aforementioned drawback of the prior art by providing an LED aperture module installed in headlights or rear lights of a motor vehicle to overcome the shortcomings of the conventional LED aperture, in hope of using a wider distribution and a greater interval among LED lamps of the LED aperture in conjunction with the bottom of a transparent light collection ring cover to form an aperture with a uniform brightness of a light source emitted through refractive engraved lines that are formed on a surface of the light collection ring cover when the automobile lamps are turned on, so as to achieve the expected safety warning and decoration functions.

Therefore, it is a primary objective of the present invention to provide an LED aperture module installed in headlights or rear lights of a motor vehicle, and the LED aperture module comprises a printed circuit board (PCB) including a plurality of LED lamps installed thereon, and a transparent light collection ring cover, wherein the LED lamps installed on the surface of the PCB are distributed with a wider interval apart from one another, and at least two notches concavely formed at the external periphery of the PCB for installing each LED lamp at a position proximate to an internal side of the light collection ring cover, and the light collection ring cover includes a plurality of refractive engraved lines formed on a surface of the light collection cover, and at least two latch sections are extended inwardly towards an internal periphery of the light collection ring cover for aligning and inserting the latch sections into the notches of the PCB respectively. When the LED lamps installed on the LED aperture module are turned on together with the automobile lamps for an illumination purpose, the refractive engraved lines formed on the surface of the light collection ring cover are provided for forming an aperture to provide a uniform brightness of the emitted light source, so as to achieve the expected safety warning and decoration functions.

Another objective of the present invention is to build a PCB including the LED lamps installed thereon and having a bottom aligned evenly with an internal side of the light collection ring cover to facilitate the light source of the LED lamp to form an aperture with an expected uniform light source by passing the light source through each refractive engraved line formed at the periphery of the light collection ring cover.

### BRIEF DESCRIPTION OF THE INVENTION

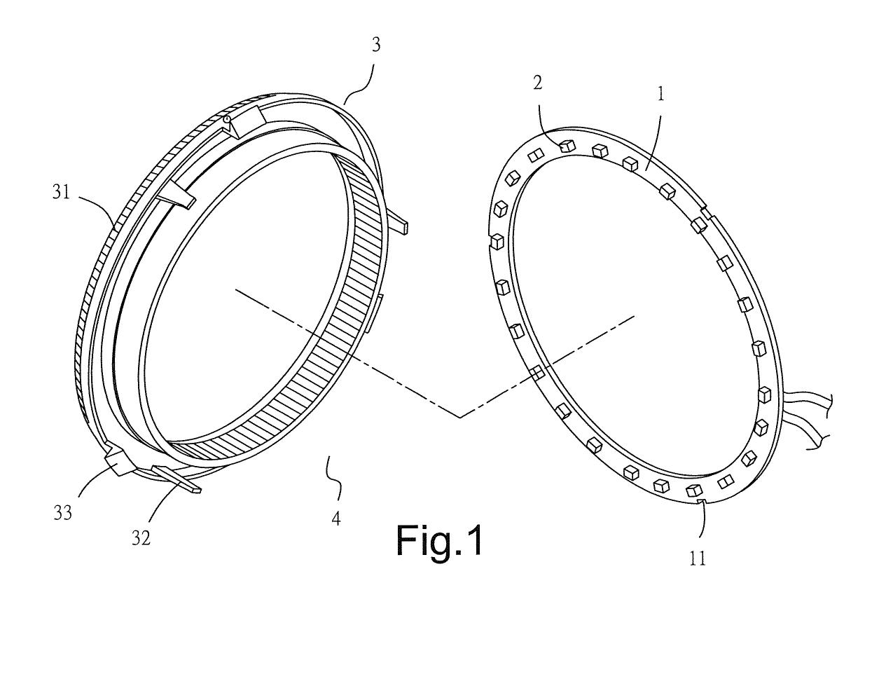

FIG. 1 is an exploded view of an LED aperture module of an automobile lamp of the present invention;

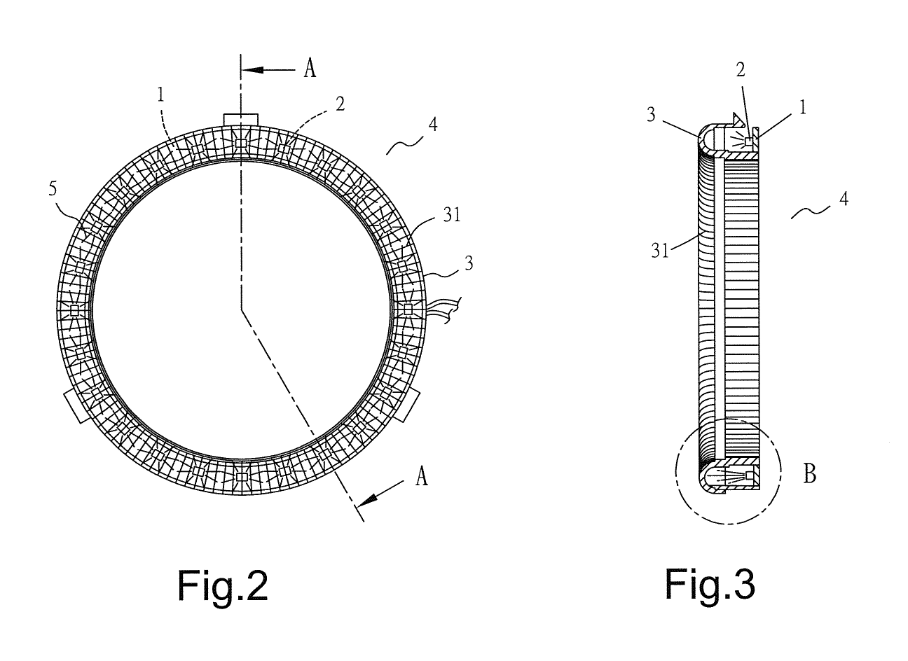

FIG. 2 is a front view of an LED aperture module of an automobile lamp of the present invention;

FIG. 3 is a cross-sectional view of Section A-A of FIG. 2;

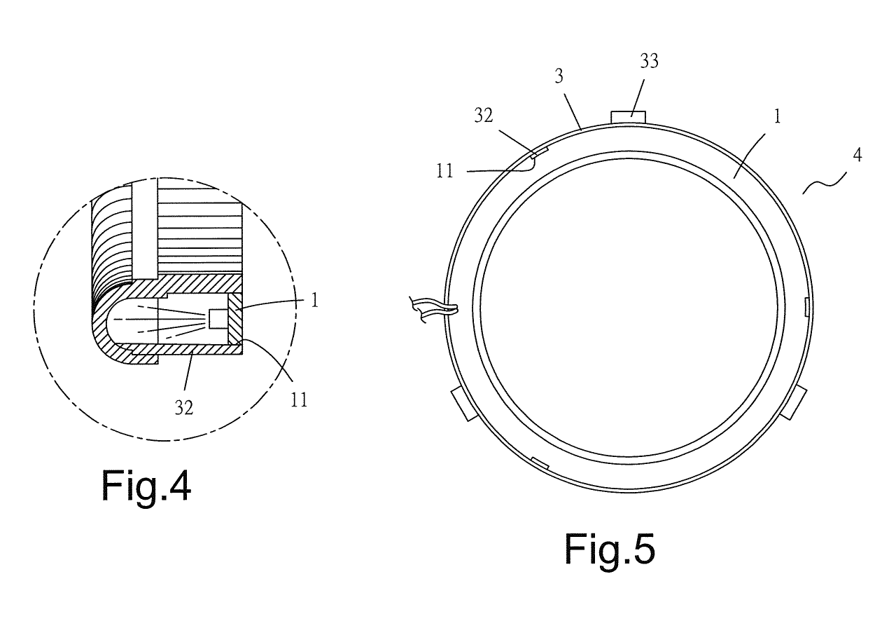

FIG. 4 is a close-up view of Part B of FIG. 3;

FIG. 5 is a rear view of an LED aperture module of an automobile lamp of the present invention; and

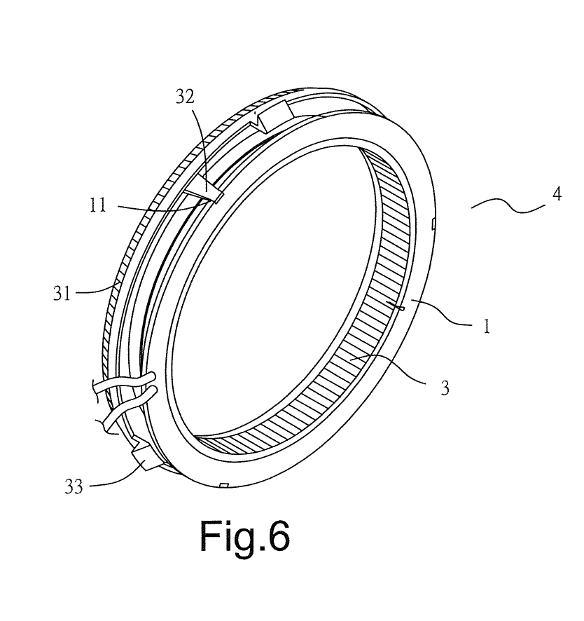

FIG. 6 is a perspective view of an LED aperture module of an automobile lamp of the present invention.

### DETAILED DESCRIPTION OF THE PREFERRED EMBODIMENTS

With reference to FIG. 1 for an improved LED aperture of an automobile lamp of the present invention, the LED aperture module 4 installed in headlights or rear lights of a motor vehicle comprises a PCB 1 including a plurality of LED lamps 2 installed thereon, and a transparent light collection ring cover 3.

In the PCB 1 with the plurality of LED lamps 2, the LED lamps 2 are installed with a relative wider interval apart from one another, and at least two notches 11 are concavely formed at the external periphery of the PCB 1.

A light collection ring cover 3 includes a plurality of refractive engraved lines 31 formed on a surface of the light collection ring cover 3, at least two latch section 32 extended from an internal periphery of the light collection ring cover 3, and at least two hooks 33 formed along the periphery of the light collection ring cover 3.

With reference to FIGS. 1 and 2 for assembling process the PCB 1 with the plurality of LED lamps 2 installed thereon and the transparent light collection ring cover 3, the bottom of the PCB 1 with the LED lamps 2 is disposed at a position proximate to an internal side of the light collection ring cover 3 as shown in FIGS. 3 and 4, and each notch 11 of the PCB 1 allows the periphery of the light collection ring cover 3 to be embedded in the corresponding latch section 32 as shown in FIG. 5 to limit the PCB 1, and the hooks 33 around the periphery of the light collection ring cover 3 is provided for latching to an internal side of a lamp casing (and the latch by the hooks is not shown in the figure), so as to form an LED aperture module 4 as shown in FIG. 6.

When the LED aperture module 4 is provided for the automobile lamps to provide an illumination as shown in FIG. 2, the LED lamps 2 are turned on with the automobile lamps (such as a high or low beam of headlights or rear lights of a motor vehicle) for the illumination, the lights emitted from a light source 5 and passing through the refractive engraved lines 31 formed on the surface of the light collection ring cover 3 are overlapped with one another due to reflections, and an aperture of the emitted light source 5 with a uniform brightness can be formed to achieve the expected safety warning and decoration function, and lower the cost of the LED lamps.

What is claimed is:

1. An improved LED aperture of an automobile lamp, comprising a printed circuit board (PCB) having a plurality of LED lamps installed therein, and a transparent light collection ring cover, characterized in that the LED lamps installed on the PCB are disposed with a relatively wider interval apart from one another, and at least two notches are concavely formed at the external periphery of PCB, such that each LED lamp is installed at a position proximate to an internal side of the light collection ring cover, and the light collection ring cover includes a plurality of refractive engraved lines formed on a surface of the light collection ring cover, and at least two latch sections extended from the internal periphery of the light collection ring cover and aligned with the notches of the PCB;
thereby, the LED lamps installed in the LED aperture module form an aperture with a uniform brightness when the automobile lamps are turned on, and lights of a light source are passed through a plurality of refractive engraved lines formed on a surface of the light collection ring cover, so as to achieve the expected safety warning and decoration functions and lower the cost of the LED lamps.

2. The improved LED aperture of an automobile lamp as recited in claim 1, wherein the bottom of the PCB with the LED lamps is aligned evenly with an internal side of the light collection ring cover to facilitate a light source of the LED lamps to pass through each refractive engraved line at the periphery of the light collection ring cover completely when the light source is used for an illumination purpose to form an aperture with the expected effect of the light source with a uniform brightness.
